(19) United States
(12) Patent Application Publication
(10) Pub. No.: US 2008/0218293 A1
(43) Pub. Date: Sep. 11, 2008

(54) High Frequency Electromagnetic Wave Receiver and Broadband Waveguide Mixer

(75) Inventors: Yong Liu, Shanghai (CN); Yun Yuan, Shanghai (CN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/912,269

(22) PCT Filed: Apr. 17, 2006
(86) PCT No.: PCT/IB2006/051182

§ 371 Date: May 9, 2008

(30) Foreign Application Priority Data
Apr. 22, 2005 (CN) 200510066326.5

(51) Int. Cl. H01P 3/00; H01P 5/12

(52) U.S. Cl. 333/126; 333/137

(57) ABSTRACT

The present invention provides a broadband waveguide mixer, comprising: a waveguide having a substantially v-shaped groove in its inner surface; a broadband antenna coupling in the V-groove; and mixing means for mixing signals received by the broadband antenna. The present invention further provides a high frequency electromagnetic wave receiver comprising the aforesaid broadband waveguide mixer. The broadband waveguide mixer and the high frequency electromagnetic wave receiver have the advantages of broad single mode operating frequency band, lower loss, lower noise, and they can be easily produced and assembled to lower cost.

### FIELD OF THE INVENTION

1. Field of the Invention

The present invention relates to a high frequency electromagnetic wave receiver, more particularly to a broadband waveguide mixer.

2. Background of the Invention

With the development of millimeter wave (30 GHz-300 GHz) and sub-millimeter wave (300 GHz-3 THz) technologies, the above frequency bands are highly possible to be applied to personal wireless broadband communication and indoor multi-media wireless access technologies. Additionally, since the atmosphere attenuation and reverse dispersion of millimeter wave are smaller than those of infrared, the band of millimeter wave is suitable for transmission and communication in atrocious weather situations (e.g., in the existence of suspended particulates like fume and dust) and therefore it can also be used as communication means for some complicated environments, such as automobile electronics and traffic navigation. Accordingly, broadband mixers, which have broad bandwidths as well as low noise and can operate in the above frequency bands, are highly desired to meet the daily increasing requirements. However, the conventional solutions cannot solve the problem of broadband reception with low noise and low cost due to their disadvantages of high cost, non-trivial structural loss, multi-mode interference, etc.

The types of existing millimeter wave mixers mainly include waveguide mixers, integrated circuit mixers and quasi-optical mixers, etc.

Waveguide mixers typically adopt rectangular waveguide or reduced-height rectangular waveguide architectures. The frequency band of this type of mixers is limited by the bandwidth of the rectangular waveguide. In particular, the size of the rectangular waveguide, which can operate in single mode within the millimeter wave band, is very small. Therefore, it makes processing and assembling difficult and increases the production costs. Although oversized rectangular guides can be adopted to solve the size problem, the multi-mode interference induced by the oversized rectangular guides is disadvantageous to the design of broadband mixers. On the other hand, because of the skin effect, the transmission loss of rectangular waveguides operating in the millimeter wave band is extremely high, which is also disadvantageous to lower the noise of the mixers.

Integrated circuit mixers are made on dielectric patches. The patches surely increase the dielectric losses during the transmission of millimeter wave signals. Especially, when the operating frequency is over 100 GHz, the losses become extremely severe. Secondly, serious parasitic parameter interference also limits the highest operating frequency of integrated circuits mixers. Thus, the existing integrated circuit type is not suitable for implementing mixers operating in the millimeter wave band.

Quasi-optical mixers made by quasi-optical waveguides generally require some optical instruments like optical gates, lens, reflective mirrors, holders, etc. Such kind of mixers is structurally complicated and oversized and requires optical alignment. Thus, it will increase the processing difficulty of the mixers and the costs of production.

In summary, using the present technologies cannot provide a mixer, which can operate in the millimeter wave band, provide good broadband performance as well as lower heat noise and are easily produced and assembled.

### SUMMARY OF THE INVENTION

The technical problem to be solved by the present invention is how to make a mixer operating in the millimeter wave band having good broadband performances as well as lower heat noise and is easier to be produced and assembled.

The invention provides a broadband waveguide mixer, comprising: a waveguide having a substantially v-shaped groove in its inner surface; a broadband antenna coupling in the V-groove; and a mixing means for mixing signals received by the broadband antenna.

The invention also provides a high frequency electromagnetic wave receiver comprising the aforesaid broadband waveguide mixer.

Since the present invention adopts the V-groove waveguide architecture, which is suitable for the transmission of millimeter waves and sub-millimeter waves, the broadband waveguide mixer and the high frequency (HF) electromagnetic wave receiver of the present invention have the advantages of broad single mode operating frequency band, lower loss, low noise and easy production and assembling. In addition, because of the broadband receiving functionality supported by the bowtie dipole antenna, which belongs to broadband antennas, the broadband waveguide mixer and HF electromagnetic wave receiver of the present invention can normally operate in a broader frequency range.

After reading the detailed description of the embodiments of the present invention in conjunction with the attached figures, the other features and advantages of the present invention would become more apparent.

### BRIEF DESCRIPTION ON THE DRAWINGS

FIG. 1 is a view showing the external structure of a V-groove waveguide mixer of an embodiment of the present invention.

FIG. 2 is a sectional view partially showing the V-groove waveguide mixer of the embodiment shown in FIG. 1.

FIG. 3 is a view showing the back surface of the patch in the V-groove waveguide mixer of the embodiment shown in FIG. 1.

FIG. 4 is an equivalent circuit diagram showing the V-groove waveguide mixer of the embodiment shown in FIG. 1.

FIG. 5 is a sectional view partially showing a V-groove waveguide mixer of another embodiment of the present invention.

FIG. 6 is a sectional view showing the V-groove waveguide mixer of the embodiment shown in FIG. 5 taken along line A-A.

FIG. 7 is an equivalent circuit diagram showing the V-groove waveguide mixer of the embodiment shown in FIG. 5.

FIG. 8 is a schematic showing an environment for a short distance communication terminal.

### DESCRIPTION OF THE PREFERRED EMBODIMENTS

In the following, the embodiments of the present invention will be described in details with reference to the attached figures.

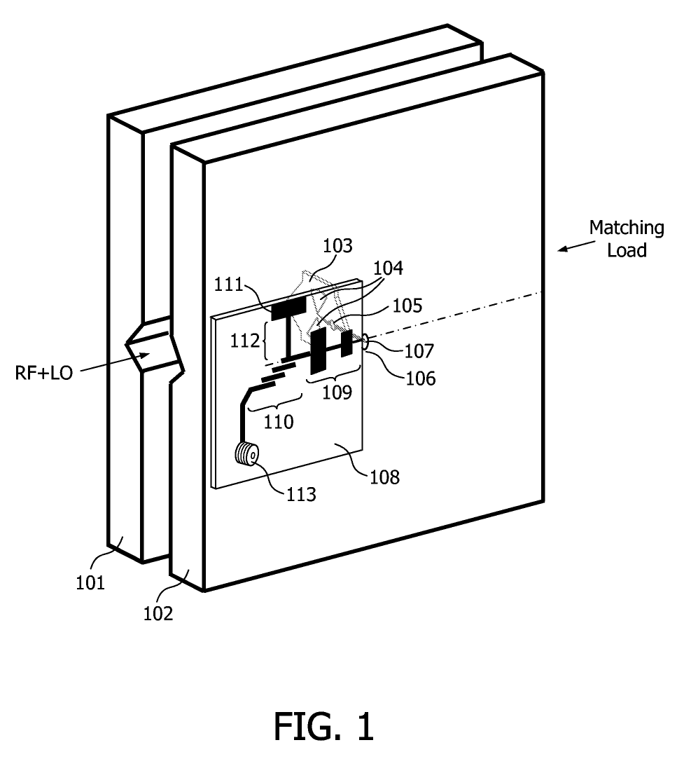

FIG. 1 is a view showing the external structure of a V-groove waveguide mixer of an embodiment of the present invention. In FIG. 1, numeral 101 and numeral 102 represent two metal plates with V-groove; numeral 103 represents an HF dielectric patch, numeral 104 represents a bowtie dipole antenna, numeral 105 represents a diode; numeral 106 represents a hole on the metal plate 102, whose inner surface has metal properties; numeral 107 represents a conductor, which is in the hole 106 and connects the diode 105 with one of its ends; numeral 108 represents a dielectric patch, on which a planar circuit is formed; numerals 109, 110, 111, 112 respectively represent an impedance conversion element, a filter element, a metal plate element and an intermediate frequency (IF) transmission line; numeral 113 represents a coaxial connector. Connections and functionalities of the components corresponding to the above numerals will be described in details hereinafter.

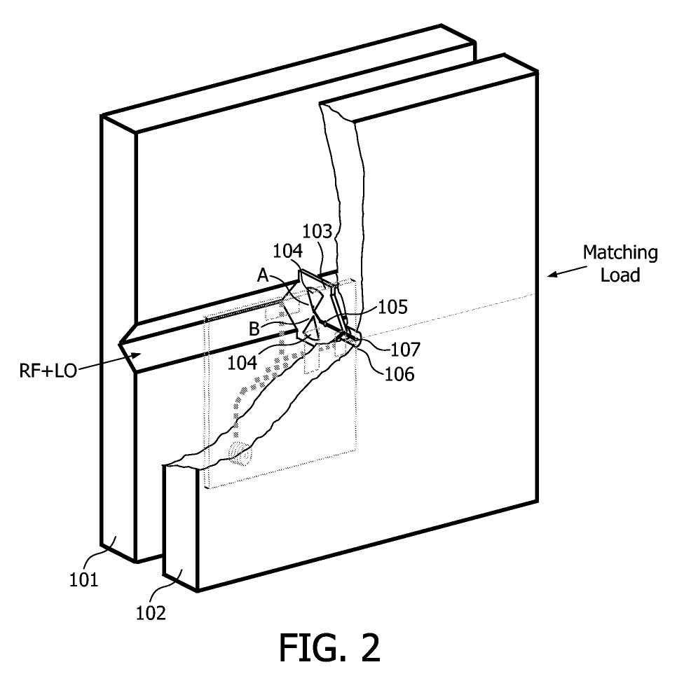

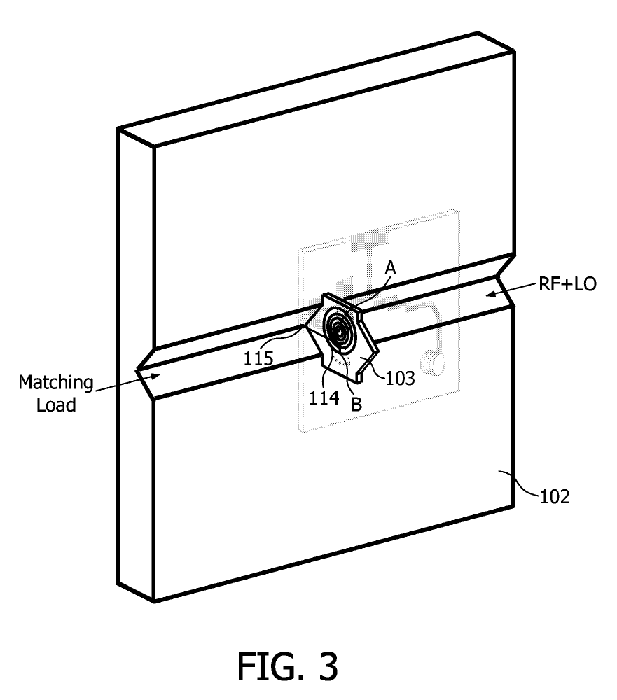

As shown in FIG. 1, the metal plate 101 and the metal plate 102 are placed in parallel and separated by some distance. Of course, the metal plate 101 and the metal plate 102 can also be substituted by non-metal plates, but the two opposite surfaces of those two non-metal plates must be processed (e.g., electroplated with metal films) so that they can have metal properties. Two respective V-grooves are formed oppositely at the corresponding positions on the inner surfaces of the metal plates 101 and 102. The patch 103 is a dielectric patch placed in the V-grooves of the metal plates 101 and 102 and positioned vertically to the metal plates 101 and 102. A planar circuit is formed on the patch 103 by means of, e.g., etching. The planar circuit comprises the bowtie dipole antenna 104, diode 105, etc (detailed components and connections will be described hereinafter with reference to FIG. 2 and FIG. 3). The patch 108 is a dielectric patch attached on the outer surface of the metal plate 102, on which a planar circuit is formed by means of, e.g., etching (detailed functional portions and connections will be described in details hereinafter). The metal plate 102 also works as the grounding plate of the planar circuit. There is a coaxial connector 113 at the end of the planar circuit of the dielectric patch 108, which works as an IF output of the mixer.

Although FIG. 1 shows that the V-grooves are formed in both of the inner surfaces of the metal plates 101 and 102, it is also possible that the V-groove is formed only in one of the inner surfaces of the metal plates. The frequency bandwidth of the V-groove waveguide is larger than that of the conventional rectangular waveguide. The broadband performance of the mixer according to the present invention benefits from the special architecture of the V-groove waveguide.

Moreover, in the V-groove waveguide, the electromagnetic field of the master mode concentrates in the V-grooves, so that the current in the metal wall is relatively weak. Thus, compared with the rectangular waveguide, the attenuation caused by the impedance of the non-ideal conductor in the metal wall is relatively low. Low attenuation is advantageous to the noise factor of the mixer.

In addition, the size of the V-groove waveguide is larger than the rectangular waveguide operating at the same frequency band. Thus, the tolerance difference of the V-groove waveguide is not as strict as the rectangular waveguide and therefore it saves the cost.

The bowtie dipole antenna 104 can be a broadband antenna in one of other shapes. The angle of the bowtie dipole antenna 104 will not constitute any limitation to the present invention. For example, the angle can range from 1° to 90°.

The diode 105 for mixing can also be a non-linear element in a different form. The different forms of different non-linear elements will not constitute any limitation to the present invention.

FIG. 2 is a sectional view partially showing the V-groove waveguide mixer of the embodiment shown in FIG. 1. FIG. 3 is a view showing the back surface of the dielectric patch 103 in the V-groove waveguide mixer of the embodiment shown in FIG. 1. Symbols A and B in FIGS. 2 and 3 represent two feeding points of the bowtie dipole antenna formed in the dielectric patch 103; numeral 114 in FIG. 3 represents an inductance coil on the back of the dielectric patch 103, and numeral 115 represents a back wiring from the feeding point B to the metal plate 102 on the back of the dielectric patch 103. In addition, the same elements in FIG. 2 and FIG. 3 as those in FIG. 1 are labeled with the same numerals, and their descriptions are omitted herein.

As shown in FIG. 2, the dielectric patch 103 is embedded in the V-grooves of the metal plates 101 and 102. In the front surface of the dielectric patch 103, the bowtie dipole antenna 104 is formed by means of, e.g., etching. The feeding points A and B are two feeding points of the two branches of the bowtie dipole antenna 104 respectively. One end of the diode 105 is connected with the feeding point A by a horizontally extended metal strip on the dielectric patch 103, and the other end is connected to the front end of the impedance conversion section 109 by another horizontally extended metal strip and the metal conductor 107 in the hole 106 on the metal plate 102 in succession, wherein the impedance conversion section 109 belongs to a planner circuit on the dielectric patch 108.

As shown in FIG. 3, the inductance coil 114 is provided on the back of the dielectric patch 103 by means of, e.g., etching. The feeding points A and B in FIG. 2 are led to the back of the dielectric patch 103 through the metalized hole 106, and are connected with each other by the inductance coil 114. At the same time, the feeding point B is connected to the metal plate 102 by the back wiring 115. The inductance coil 114 and the metal wiring 115 are insulated with each other.

As shown by the arrows in FIG. 1 to FIG. 3, a RF signal and a Local Oscillator (LO) signal enter into the V-groove waveguide mixer along the direction of the V-grooves. When they meet the bowtie dipole antenna 104 in the dielectric patch 103, a resultant signal of RF and LO is excited at the feeding points A and B of the antenna 104. After mixed by the diode 105 on the dielectric patch 103, the signal passes through the hole 106 on the metal plate 102 and is outputted to the outside of the V-groove waveguide through the conductor 107 so as to be outputted to the front end of the impedance conversion section 109 belonging to the planar circuit in the dielectric patch 108. The main functionalities of the planar circuit in the dielectric patch 108 are filtering the output signals of the diode 105 and providing bias voltage to diode 105. The impedance conversion section 109 can convert the coaxial impedance formed by hole 106 and the conductor 107 into a micro-strip line impedance of 50 ohm. A larger capacitance is formed between the metal chip 111 and the grounded metal plate 102. When operating, the anode of the DC bias voltage of the diode 105 is applied to one end of the diode by the metal chip 111 through the impedance conversion section 109. Its cathode is applied to the metal plate 102 and is connected to the other end of the diode 105 through the back wiring 115, the feeding point B, inductance coil 114 and the feeding point A in succession, wherein the inductance coil 114 presents very large reactance to RF and LO signals whereas IF signals and DC signals can pass through it smoothly. Thus, the bias voltage for the diode 105 located in the V-groove waveguide can be easily provided by applying a DC bias power supply between the metal chip 111 and the metal plate 102. In addition, the metal chip 111 can be regarded as the capacitor which shorts the IF, and it is connected to the rear end of the impedance conversion section 109 with an intermediate frequency transmission line 112 of λ/4, wherein λ is the wavelength of the intermediate frequency signal. The filter section 110 is a band-pass filter, which filters the IF component. At the same time, the filter section 110 can also isolate the DC voltage. The mixed signal is IF filtered by the filter section 110, and then the coaxial connector 113 outputs the final mixed signal.

As shown by the arrows in FIG. 1 to FIG. 3, a matching load is connected with the other end of the V-groove waveguide mixer. It can absorb all the energy of the RF and LO signals, which cannot be absorbed by the bowtie dipole antenna 104, so as to guarantee the broadband performance of the mixer. The matching load can be made of some absorbing materials such as graphite.

In addition, in the present embodiment, the planar circuit of the dielectric patch 108 on the external wall of the metal plate 102 should be equipped with a metal screening enclosure (not shown) when the mixer is in operation, in order to prevent foreign signals from coming into the planar circuit of the dielectric patch 108, which may cause some undesired disturbance.

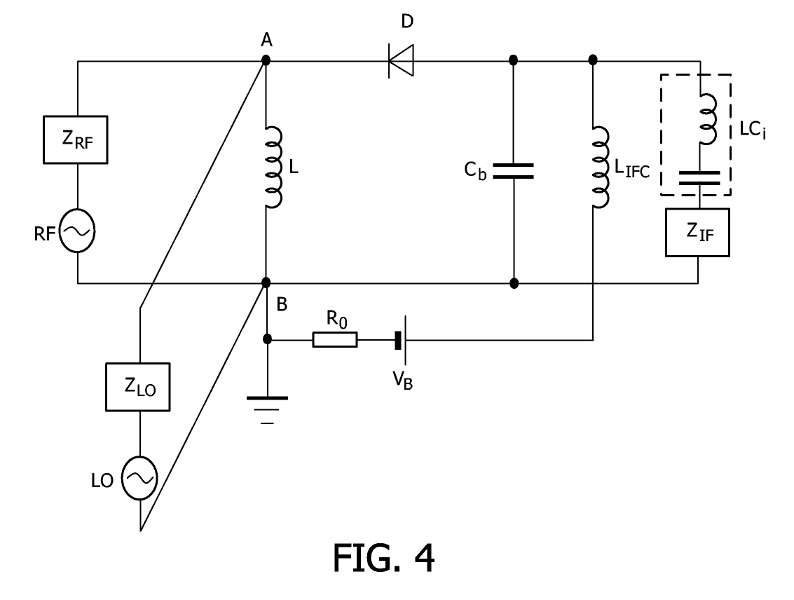

FIG. 4 is an equivalent circuit diagram showing the V-groove waveguide mixer of the embodiment shown in FIG. 1. Source RF and source LO represent the RF input signal and the LO input signal respectively, and Z_{RF} and Z_{LO} represent intrinsic input impedances for those two sources. V_{B} is a DC source, which provides bias voltage to the diode D, and R_{O} represents its intrinsic impedance. Z_{IF} represents an IF load of the mixer. Circuit nodes A and B correspond to the two feeding points of the bowtie dipole antenna 104. The inductance coil L between the node A and the node B is equivalent to the inductance coil 114 on the back of the dielectric patch 103 shown in FIG. 3. The HF return path capacitor C_{b} is equivalent to the impedance conversion section 109 of the planar circuit on the dielectric patch 108 shown in FIG. 3. The resonant circuit LCᵢ, which is connected in series with the IF load Z_{IF}, is equivalent to the filter section 110 of the planar circuit on the dielectric patch 108 shown in FIG. 1. L_{IFC} is equivalent to the IF transmission line 112 of λ/4 on the dielectric patch 108 shown in FIG. 1. The DC voltage V_{B} is applied to one end of the diode D through L_{IFC}, and prevents the IF from leaking along the DC bias circuit.

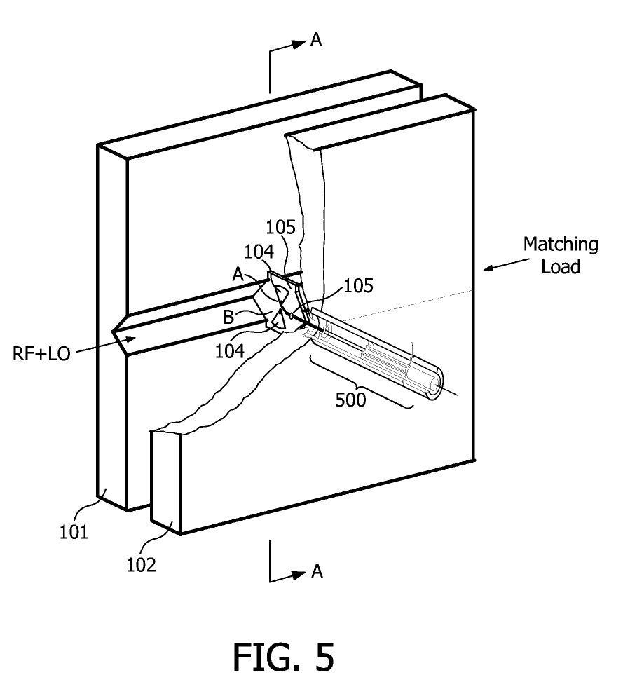

FIG. 5 is a sectional view partially showing a V-groove waveguide mixer of another embodiment of the present invention. The same elements in FIG. 5 as those in FIG. 1 are labeled with the same numerals, and their descriptions are omitted herein. Numeral 500 represents the output and bias section, which filters and outputs the mixed IF and provides bias voltage to the diode 105. The output and bias section 500 can be fixed tightly on the metal plate 102 by means of e.g., a screw structure.

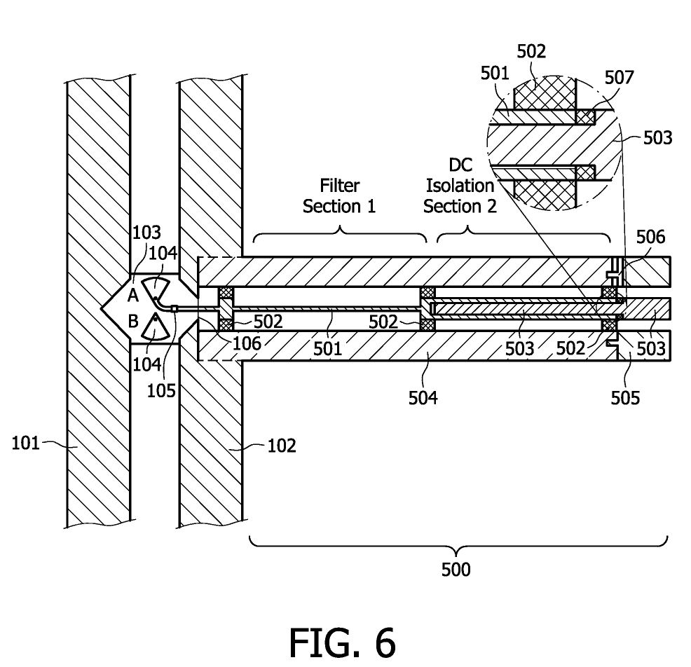

FIG. 6 is a sectional view showing the V-groove waveguide mixer of the embodiment shown in FIG. 5 taken along line A-A. The structure of the output and bias section 500 of FIG. 5 is shown in details in FIG. 6.

In the embodiment shown in FIG. 5 and FIG. 6, the V-groove waveguide (including the bowtie dipole antenna 104) is the same as that in the embodiment shown in FIGS. 1-4. Only the output and bias section 500 will be described in detail hereinafter. As shown in FIG. 6, the metal conductor labeled with numeral 501 and the metal conductor labeled with numeral 504 forms a coaxial conductor. The internal conductor 501 and the external conductor 504 are separated from each other by a gasket 502, which is made of some dielectric materials. In the filter section 1, the internal conductor 501 is a solid metal bar with thick and thin segments alternated, while in the DC isolation section 2, the internal conductor 501 is a hollow cylinder and is equipped with another conductor core 503 inside it. As shown by the partially enlarged view in FIG. 6, the diameter of the inserting end of the conductor core 503 is slightly smaller than the inner diameter of the internal conductor 501. Thus, a small gap can be formed between the internal conductor 501 and the conductor core 503 by using the gasket indicated by numeral 507, and because of the gap, the two conductors cannot contact each other so that they form a capacitor. At the other end of the external conductor 504, a conductor 505 is attached by using e.g., tenon structures. Numeral 506 is a through hole at the joint of the external conductor 504 and the conductor 505.

While operating, the output of the diode 105 is connected with the internal conductor 501 of the coaxial filter in the output and bias section 500. The signals mixed by non-linear elements are filtered by the filter section 1 formed by the internal conductor 501 and the external conductor 504, and the desired IF signals are accordingly obtained. The IF signals pass through the DC isolation section 2 and are finally outputted at the end of the conductor 503. In the structure of the present embodiment, it is easy to provide DC bias voltage to the diode 105. For example, one end of the DC source can be applied to the external conductor 504 (equivalent to applying the source to the conductor 505 or the metal plate 102), and the other end of the source can be applied to the internal conductor 501 through the through hole 506 so that the DC power is supplied to the diode 105. The through hole 506 acts as a cut-off circular waveguide to the IF signals, and it can prevent the IF signals from leaking to the outside of the output and bias section 500 via the through hole 506. The DC isolation section 2, i.e. the capacitor formed by the internal conductor 501 and the conductor 503, can prevent the DC bias voltage from being applied to a IF amplifier by the IF output end, i.e., the conductor core 503 and the conductor 505, which may result the loss of the IF amplifier.

As shown by the arrows in FIG. 5, in the same way, a matching load is connected with the other end of the V-groove waveguide mixer. It can absorb the energy of the RF and LO signals which are not absorbed by the bowtie dipole antenna 104 so as to guarantee the broadband performance of the mixer. The matching load can be made of some absorbing materials such as graphite.

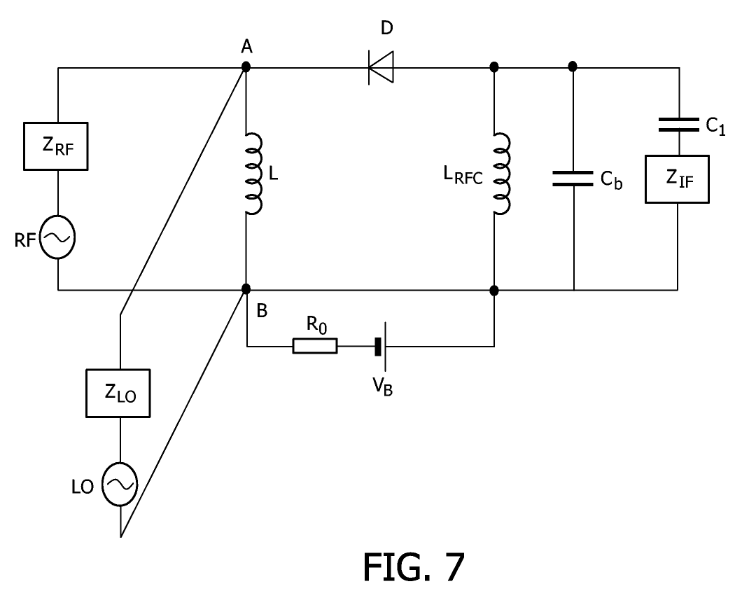

FIG. 7 is an equivalent circuit diagram showing the V-groove waveguide mixer of the embodiment shown in FIG. 5. The source RF and the source LO as well as their intrinsic impedance Z_{RF} and Z_{LO}, the DC source V_{B} as well as its intrinsic impedance R₀, the IF load Z_{IF}, the circuit nodes A and B, the inductance coil L and the diode D have the same meaning and functionalities as those in the equivalent circuit of the first embodiment shown in FIG. 4, thus their descriptions are omitted herein. The capacitor C_{b} is equivalent to the filter section 1 formed by the internal conductor 501 and the external conductor 504 shown in FIG. 6, and it can short the RF and LO signals and prevent the mixed IF signals from being shorted. The capacitor C₁ connected in series with IF load Z_{IF} is equivalent to the DC isolation section 2 formed by the internal conductor 501 and the conductor core 503 shown in FIG. 6, and it can prevent the DC bias voltage from being applied to the IF output end. As described above, both of the two embodiments of the present invention adopt the V-groove waveguide structure, which comprises a bowtie dipole antenna 104. The difference between the two embodiments is the form of outputting the IF signals after mixing and the form of providing DC bias voltage to the diode 105. The form adopted by the output and bias section of the broadband waveguide mixer does not constitute any limitation to the scope of the present invention. Those skilled in the art can design and produce, based on the present invention, various output and bias sections, which can meet their practical requirements.

In the above, several embodiments of the broadband waveguide mixers of the present invention are described with reference to FIGS. 1-7. Those skilled in the art can easily apply the broadband waveguide mixer to a HF electromagnetic wave receiver so as to obtain a HF electromagnetic wave receiver of the present invention.

In general, the HF electromagnetic wave receiver of the present invention, besides the IF processing unit and some other elements, comprises a broadband waveguide mixer. The broadband waveguide mixer comprises: a waveguide with a V-groove provided in its inner surface; a broadband antenna provided within the V-groove; and an output and bias section connected with the broadband antenna and used to output IF signals.

The description about the broadband waveguide mixer used in the HF electromagnetic wave receiver of the present invention can refer to the corresponding description about FIG. 1 to FIG. 7, and it is omitted herein.

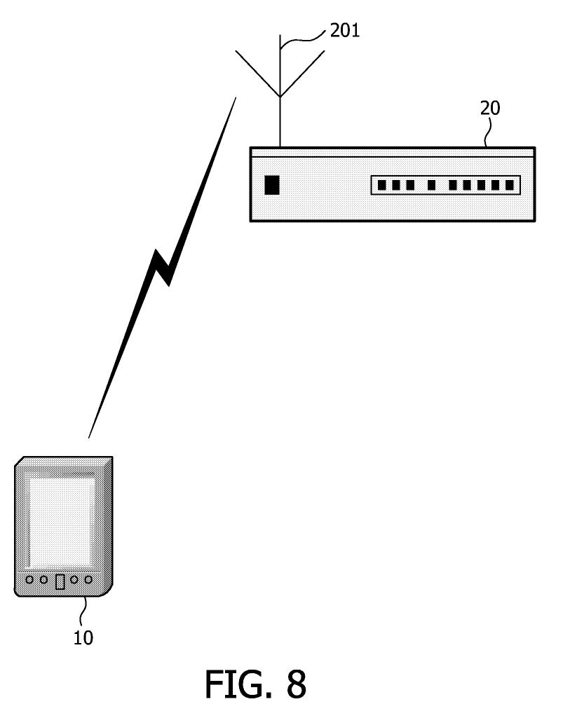

The HF electromagnetic wave receivers and the broadband waveguide mixers of the present invention can be applied to several types of wireless communication devices, e.g., spectrum analyzers and radio telescopes, etc. In addition, since the HF electromagnetic wave receivers and the broadband waveguide mixers of the present invention have the characteristic of directional receiving, they are also suitable to be used in indoor short distance communication systems. As shown in FIG. 8, a transmission device (e.g. wireless router) 20 has a directional transmission antenna 201, while a receiving terminal 10 is equipped with a HF electromagnetic wave receiver or a broadband waveguide mixer of the present invention to directionally receive the HF electromagnetic signals transmitted from the directional antenna 201. Using the directional transmitting/receiving characteristic in the indoor short distance communication system can bring the advantages of improving transmission efficiency and lowering the electromagnetic wave radiation to human bodies.

Although the embodiments of the present invention are described in conjunction with the appended figures, those skilled in the art can make various modifications and variations within the scope of the appended claims.

1. A broadband waveguide mixer, comprising:
a waveguide having a substantially v-shaped groove in its inner surface;
a broadband antenna coupling in said V-groove; and
a mixing means for mixing signals received by said broadband antenna.

2. The broadband waveguide mixer according to claim 1, wherein said mixing means comprises a non-linear element for mixing.

3. The broadband waveguide mixer according to claim 2, further comprising:
a dialectic patch provided within said V-groove, said broadband antenna being formed on said dielectric patch.

4. The broadband waveguide mixer according to claim 2, wherein said non-linear element is a diode for mixing.

5. The broadband waveguide according to claim 2, wherein said mixing means comprises:
an impedance conversion means for matching mixed signals outputted from said non-linear element;
a filter means for filtering signals outputted by said impedance conversion means and outputting corresponding IF signals; and
a bias means for providing bias voltage to said non-linear element.

6. The broadband waveguide mixer according to claim 2, wherein said mixing means comprises:
an external conductor;
an internal conductor invaginating in said external conductor, comprising a first section and a second section, wherein said non-linear element is connected with said first section, and said external conductor and said first section form filter means for filtering IF signals; and
a core conductor invaginating in said second section of said internal conductor, wherein said core conductor and said second section form DC isolation means for isolating bias voltage and outputting filtered IF signals.

7. The broadband waveguide mixer according to claim 1, wherein said waveguide comprises a first plate and a second plate which are separated by a certain distance, said V-groove is provided in the inner surface of at least one of said first plate and said second plate, and inner surfaces of said first plate and said second plate have metal properties.

8. The broadband waveguide mixer according to claim 7, wherein said broadband antenna is substantially vertical to the inner surfaces of said first plate and said second plate.

9. The broadband waveguide mixer according to claim 1, wherein said broadband antenna is a dipole antenna.

10. A high frequency electromagnetic wave receiver, comprising:
a broadband waveguide mixer comprising:
a waveguide with a substantially v-shaped groove provided in its inner surface;
a broadband antenna provided in said V-groove; and
mixing means for mixing signals received by said broadband antenna; and
an intermediate frequency processing means for further processing mixed signals.

11. The high frequency electromagnetic wave receiver according to claim 10, wherein said broadband waveguide mixer further comprises:
a dielectric patch provided within said V-groove, said broadband antenna being formed on said dielectric patch.

12. The high frequency electromagnetic wave receiver according to claim 11, wherein said waveguide comprises:
a first plate and a second plate which are separated by a certain distance, said V-groove is provided in an inner surface of at least one of said first plate and said second plate, and inner surfaces of said first plate and said second plate have metal properties.

13. The high frequency electromagnetic wave receiver according to claim 12, wherein said broadband antenna is substantially vertical to inner surfaces of said first plate and said second plate.

14. The high frequency electromagnetic wave receiver according to claim 10, wherein said broadband antenna is a dipole antenna.
